(19) United States
(12) Patent Application Publication
(10) Pub. No.: US 2008/0145750 A1
(43) Pub. Date: Jun. 19, 2008

(54) ELECTRICITY SUPPLY SYSTEM

(76) Inventor: Szu-Nan Yang, Taipei (TW)

Correspondence Address: IPSG, P.C., P.O. BOX 700640, SAN JOSE, CA, 95170, US

(21) Appl. No.: 11/755,657

(22) Filed: May 30, 2007

(30) Foreign Application Priority Data
Dec. 18, 2006 (TW) 095147493
Dec. 22, 2006 (CN) 200610170005.4

(51) Int. Cl. H01M 2/18

(52) U.S. Cl. 429/142; 429/247

(57) ABSTRACT

A system for supplying electricity to one or more electronic components on a circuit substrate is disclosed. The system may include a first conversion unit configured to perform a first chemical-electrical energy conversion. The system may also include a first conductor electrically coupled with the first conversion unit and representing a first electrode of the system. The system may also include a second conversion unit configured to perform a second chemical-electrical energy conversion. The system may also include a second conductor electrically coupled with the first conversion unit and representing a second electrode of the system. The system may also include a separator disposed between the first conversion unit and the second conversion unit and configured to separate the first conversion unit from the second conversion unit. The separator may be a portion of the circuit substrate.

### RELATED APPLICATIONS

The present invention claims priority under 35 USC 119(b) to a commonly owned foreign patent application filed in Taiwan entitled “ELECTRICITY SUPPLY SYSTEM,” Taiwan Application No. 095147493, Attorney Docket No. T098-06001TW, filed on Dec. 18, 2006 by inventor Szu-Nan Yang; the present invention claims priority under 35 USC 119(b) to a commonly owned foreign patent application filed in China entitled 37 ELECTRICITY SUPPLY SYSTEM,” China Application No. 200610170005.4, Attorney Docket No. P1061290, filed on Dec. 22, 2006 by inventor Szu-Nan Yang.

### BACKGROUND OF THE INVENTION

In the electronic device industry, portability is one of the major trends. A portable electronic device typically requires an electricity supply system/module to supply electricity for functional components/modules. Typically, electricity supply modules (e.g., a battery module) and functional modules (e.g., a module including one or more of memory, computing, and display components) are implemented in separate units, as illustrated in the example of FIG. 1.

FIG. 1 illustrates a battery 101 configured to supply electricity for a functional module 102. Battery 101, e.g., a lithium battery, may typically include conversion units 112 and 113 configured to perform conversation between chemical energy and electrical energy. Conversion units 112 and 113 may be separated by separator 111 to prevent short circuit between conversion units 112 and 113.

Battery 101 may further include conductors 114 and 115 configured to collect currents and to form part of an electrical path between conversion units 112 and 113 and functional module 102. Conductors 114 and 113 may be electrically coupled with contacts 121 and 122, respectively, of functional module 102 through tab 141 and tab 151, respectively. Contacts 121 and 122, in turn, may be electrically coupled with circuit 123 that includes various components for performing various functions.

Tab 141 and tab 151 may serve as interfaces between battery 101 and functional module 102 (or a charger for battery 101). Typically, alignment between tabs 141 and 151 and contacts 121 and 122 may be required to ensure reliable electricity supply. Requirements of precise alignment between tabs 141 and 151 and contacts 121 and 122 may incur significant manufacturing costs.

Further, to ensure reliable and stable electricity supply, the relative position between taps 141 and 151 and contacts 121 and 122 may need to be maintained. As a result, the combined electronic device 100 that includes battery 101 and functional module 102 may be unable to be made flexible.

If conductive wires 181-182 are implemented between contacts 121-122 and tabs 141 and 151 to provide flexibility, alignment of more contact points may be required, and manufacturing costs may be increased. Further, conductive wires 181-182 may not be able to withstand a large number of a high frequency of bending. Damage to wires 181-182, e.g., resulted from bending, may cause electronic device 100 to malfunction.

In general, battery 101 may include package 116 for enclosing various components of battery 101 to prevent moisture intake and electrolyte leakage of battery 101. However, tabs 141 and 151 may typically be required to protrude from package 116 to perform interface functions for power supply and recharge. Typically, package 116 may be formed of a material that is different from the material of tabs 141 and 151). Even if sealing means, such as solder, may be applied at the junctions of package 116 and tabs 141 and 151, gaps may still exist at the junctions. Accordingly, package 116 may not be able to effectively prevent electrolyte leakage and moisture intake. As a result, performance of battery 101 may deteriorate. In order to minimize or eliminate the gaps, the manufacturing and/or material costs of battery 101 may be increased.

As also can be appreciated from the example of FIG. 1, battery 101 and functional module 102 may require different packages. The separate packages also may incur significant manufacturing and material costs.

### SUMMARY OF INVENTION

An embodiment of the present invention relates to a system for supplying electricity to one or more electronic components. At least a first electronic component of the one or more electronic components may be disposed on a circuit substrate. The system may include a first conversion unit configured to perform a first chemical-electrical energy conversion. The system may also include a first conductor electrically coupled with the first conversion unit and representing a first electrode of the system. The system may also include a second conversion unit configured to perform a second chemical-electrical energy conversion. The system may also include a second conductor electrically coupled with the first conversion unit and representing a second electrode of the system. The system may also include a separator disposed between the first conversion unit and the second conversion unit and configured to separate the first conversion unit from the second conversion unit. The separator may be a portion of the circuit substrate. The first electrode and the second electrode have different polarities.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates air example prior-art battery configured to supply electricity for a functional module.

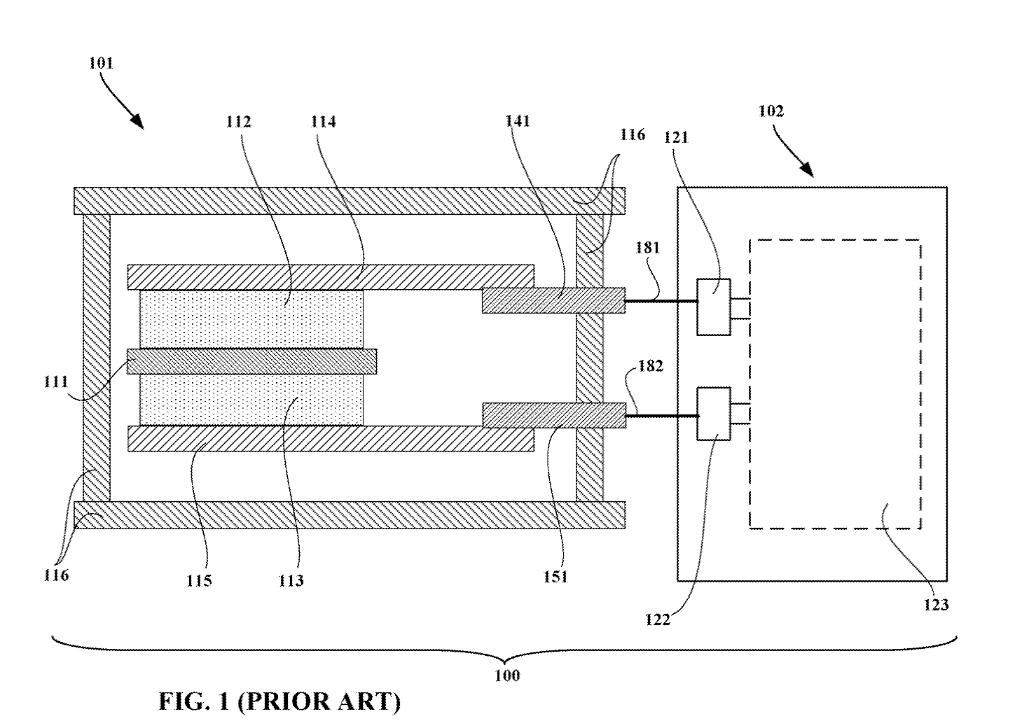

FIG. 2 illustrates an electronic module/device including an electricity supply system and a functional portion in accordance with one or more embodiments of the present invention.

FIG. 3 illustrates a partial cross-sectional view of an electricity supply system in accordance with one more embodiments of the present invention.

FIG. 4 illustrates a partial cross-sectional view of an electronic device including an electricity supply system in accordance with one or more embodiments of the present invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

One or more embodiments of the invention relate to a system for supplying electricity to one or more electronic components. At least a first electronic component of the one or more electronic components may be disposed on a circuit substrate. The circuit substrate may be a flex circuit board or a rigid circuit board.

The system may include a first conversion unit, configured to perform a first chemical-electrical energy conversion. The system may also include a first conductor electrically coupled with the first conversion unit and representing a first electrode of the system. The system may also include a second conversion unit configured to perform a second chemical-electrical energy conversion. The system may also include a second conductor electrically coupled with the first conversion unit and representing a second electrode of the system. The first electrode and the second electrode may have different polarities.

The system may also include a separator disposed between the first conversion unit and the second conversion unit. The separator may be formed of material including at least one of polyimide (PI), polyethylene terephthalate (PET), polyethylene naphthalate (PEN), glass fiber, and liquid crystal polymer. The separator may be configured to separate the first conversion unit from the second conversion unit, thereby preventing a short circuit between the first conversion unit and the second conversion unit or reducing the likelihood thereof. The separator may be a portion of the circuit substrate. The separator may include through holes, for example, having diameters greater than 10 microns, for allowing an ion flow between the first conversion unit and the second conversion unit.

The system may also include a first insulator disposed between the first conversion unit and the separator. The first insulator may include through holes with diameters less than 10 microns. The first insulator may be formed of material including one or more of a polymer material, a stiffener material (e.g., a ceramic material), etc. The polymer may include one or more of poly vinylidene fluoride (PVDF), poly vinylidene fluoride-hexafluoropropylene (PVDF-HFP), poly ethylene oxide (PEO), poly acrylonitrile (PAN), polyimide (PI), etc. The stiffener material may include one or more of SiO₂, TiO₂, Al₂O₃, etc.

The PI may be configured to maintain particles of the stiffener material in place when the first insulator is adhere to tire conversion unit, thereby preventing the particles from concentration at the interface between the first insulator and the first conversion unit. The first insulator may include one layer or a plurality of layers. The plurality of layers may have different composition recipes.

The system may further include a second insulator disposed between the second conversion unit and the separator, the second insulator including holes (e.g., through holes) with diameters less than 10 microns. The first and second insulators may be configured to prevent a short circuit between the first conversion unit and the second conversion unit or reduce the likelihood thereof. The first and second insulators may also be configured to allow an ion flow between the first conversion unit and the second conversion unit.

The system may also include a packaging unit configured to surround the first conversion unit. The packaging unit may be electrically coupled with the first conductor and a conductive element disposed on the circuit substrate.

The system may also include an inert unit disposed between the first conversion unit and the packaging unit. The inert unit may be electrically non-conductive and inert to the first conversion unit. For example, the inert unit may include an oxidized metal unit and/or a metal unit with polymer coating.

The system may also include a supporting structure configured to maintain separation between the first conductor and the second conductor and/or a conductive element disposed on the circuit substrate. The conductive element and the supporting structure may be disposed on different sides of the circuit substrate.

The system may further include a polymer unit covering the first conductor. The polymer may span beyond the supporting structure. The polymer unit includes one or more via holes. One or more inside wails of the one or more via holes are coated with conductive material. A second electronic component of the one or more electronic components may overlap at least one of the first conductor and the second conductor. For example, the second electronic component may be disposed on the polymer unit and electrically coupled with the first conductor by the conductive material.

One or more embodiments of the invention relate to an electrical module that includes the electricity supply system or a variation of the electricity supply system.

One or more embodiments of the invention relate to an electronic device that includes the electricity supply system or a variation of the electricity supply system.

The features and advantages of the present invention may be better understood with reference to the figure and discussions that follow.

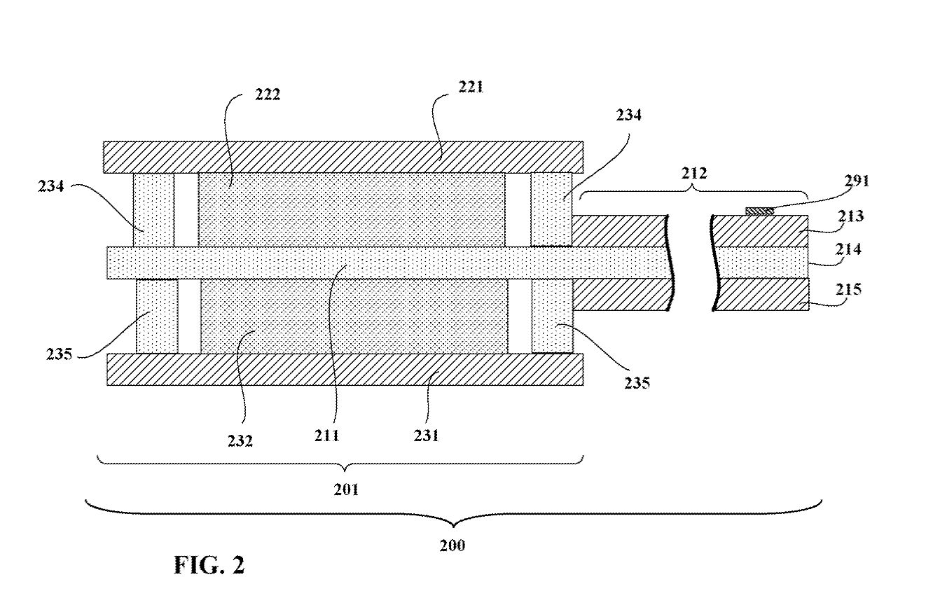

FIG. 2 illustrates an electronic module/device 200 (electronic device 200) including an electricity supply system 201 and a functional portion 212 in accordance with one or more embodiments of the present invention. Electricity supply system 201 may include a first conversion unit 222 and a second conversion unit 232 configured to perform chemical-electrical energy conversions.

Electricity supply system 201 may also include a separator portion 211 disposed between first conversion unit 222 and second conversion unit 232 and configured to separate first conversion unit 222 from second conversion unit 232. Separator portion 211 may represent a portion of a circuit substrate 214 of electronic device 200.

Electricity supply system 201 may further include first conductor 221 electrically coupled with first conversion unit 222 to perform one or more functions, such as current collection. Similarly, electricity supply system 201 may also include second conductor 231 electrically coupled with second conversion unit for performing current collection, etc.

Electricity supply system 201 may further include first packaging unit 234 configured to surround first conversion unit 222 and to prevent electrolyte leakage and/or moisture intake for conversion unit 222. First packaging unit 234 may also be configured to form part of an electrical path between first conductor 221 and first conductive element 213 on functional portion 212 on circuit substrate 214. Through first conductor 222, first packaging unit 234, and first conductive element 213, electronic component 291 on circuit substrate 214 may be able to receive electricity supply from electricity supply system 201.

First conductive element 213 may have a single layer or multilayer structure, and may be formed of material including one or more of copper, aluminum, nickel, etc., and one or more alloys thereof. Circuit substrate 214 also may have a single layer or multilayer structure. Circuit substrate 214 may include one or more structures formed of materials including one or more of PI, PET, PEN, glass fiber, liquid crystal polymer, epoxy, acrylic acid reagent, etc. Functional portion 212 may include logic circuitry and components. The logic circuitry may include wires/traces electrically coupled with electricity supply system 201 through first conductive element 213 or second conductive element 215.

Electronic device 200 may also include a second conductor 231, a second packaging unit 235, and a second conductive element 215 having configurations and functions similar to those of corresponding counterparts, such as first conductor 221, first packaging unit 234, and first conductive element 213.

Electricity supply system 201 and functional portion 212 may form an integrated part of electronic device 200 with reliable electrical coupling. If packaging is required, only one packaging unit may be required for the integrated part. Advantageously, manufacturing and material costs may be reduced.

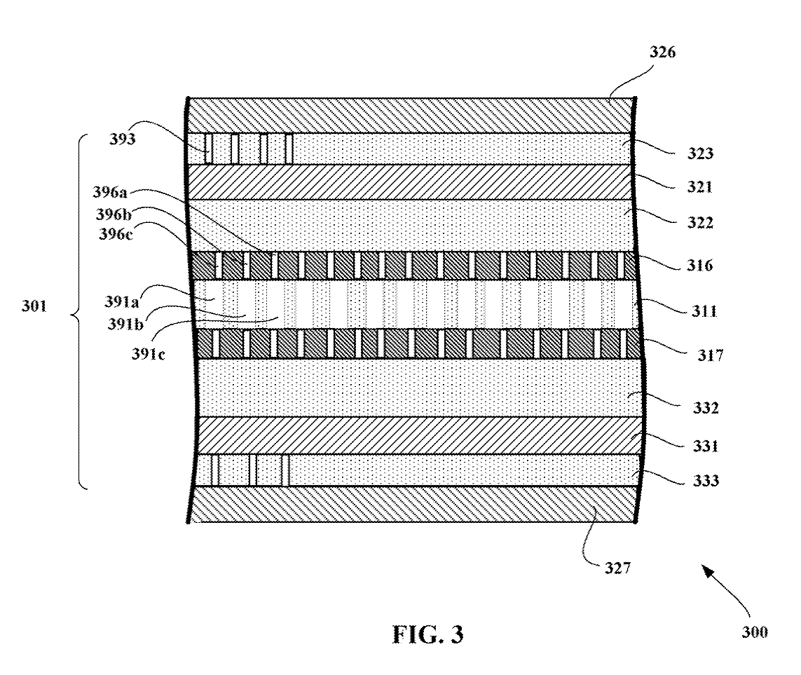

FIG. 3 illustrates a partial cross-sectional view of an electricity supply system 303 in accordance with one more embodiments of the present invention. Electricity supply system 301 may be part of electronic device 300. Electricity supply system 301 may include conversion units 322 and 332. Each of conversion units 322 and 332 may include active material (e.g., ceramic material), polymer binder, conductive material

Electricity supply system 301 may a separator portion 311 disposed between conversion units 322 and 332. Separator portion 311 may represent a portion of a circuit substrate of an electronic module/device. Separator portion 311 may include a plurality of through holes, e.g., through holes 391a-c, configured to allow ion migration (or ion flow) between conversion units 322 and 332.

Each of through holes 391a-c may have a diameter (a dimension) greater than 10 microns, for example, between 20 microns and 500 microns. Through holes 391a-c may be formed utilizing one or more well-known techniques/tools, such as one or more of etching, laser penetration, erosion, punching, drilling, etc, for example, after conductive layers (similar to conductive elements 213 and 215 shown in the example of FIG. 2) on the circuit substrate has been removed. With the relatively large sizes of through holes 391a-c, flexibility of separator portion 311 and, accordingly, the flexibility of electricity supply system 301, may be improved.

Electricity supply system 301 may also include a first insulator 316 disposed between separator portion 311 and conversion unit 322. Formed of porous material, first insulator 316 may include a plurality of through holes, e.g., through holes 396a-c, configured to allow ion flow between conversion units 322 and 332. Each of through holes 396a-c may have a diameter (a dimension) that is less than 10 microns. The small size of each of through holes 396a-c reduce the flow rate of ions, thereby preventing a short circuit between conversion units 322 and 332, while allowing ion migration for electricity supply and recharge of electricity supply system 301. Further, aging of conversion units 322 and 332 caused by local overload of the conversion units may be mitigated or prevented, given the ion migration.

First insulator 316 may be formed of material including one or more of polymer material, stiffener material, etc. For example, the polymer material may include one or more of poly vinylidene fluoride (PVDF), poly vinylidene fluoride-hexafluoropropylene (PVDF-HFP), poly ethylene oxide (PEG), poly acrylonitrile (PAN), polyimide (PI), etc. The stiffener material may include one or more of SiO₂, TiO₂, Al₂O₃, etc. The stiffener material may be configured to improve ion conductivity of first insulator 316 and to impregnate electrolytes. One or more surfaces of first insulator 316 may be by drophobicized.

First insulator 316 may be chemically adhered to conversion unit 322 utilizing one or more of gel electrolyte, plasticizer, etc. though hot lamination. During the adhesion/lamination process, polymer segments, chains, or event backbones of conversion unit 322 and first insulator 316 may be softened to migrate or rotate. PI in first insulator 316 and/or conversion unit 322 may maintain stiffener material particles in place, such that the particles may not concentrate at the interface between conversion unit 322 and first insulator 316. Advantageously, flexibility at the interface may be maintained, and electricity supply system 301 may be bent without first insulator 316 being detached from conversion unit 322. According, electricity supply system 301 may be mechanically and structurally flexible with optimal performance and durability.

In one or more embodiments, a polymer material may represent about 60% to about 95% of the volume of first insulator 316, and a stiffener material may represent about 5% to about 40% of the volume of first insulator 316. The polymer material may include PVDF, PVDF-HFP, PEO, and/or PAN. A solution may be formed including the polymer material, the stiffener material, and a solvent (e.g., NMP or Acetone). A non-solvent (e.g., PC or Propanol) with weight of about 0.5˜3.0 times the weight of the polymer material may be added to the solution to produce a new solution. Solid content may represent about 5% to about 30% of the new solution, and the solvent may represent about 95% to about 70% of the new solution. First insulator 316 (and second insulator 317) may be formed on separator portion 311 utilizing the new solution through coating, dipping, and/or spraying with (subsequent) removal of the solvent and non-solvent.

j In one or more embodiments, a polymer material may represent about 25% to about 40% of the volume of first insulator 316, and a stiffener material may represent about 75% to about 95% of the volume of first insulator 316. The polymer material may include PVDF and/or PVDF-HFP. A solution may be formed including the polymer material, the stiffener material, a solvent, and a non-solvent. Solid content may represent about 15% to about 45% of the solution, and the solvent may represent about 85% to about 55% of the solution. First insulator 316 (and second insulator 317) may be formed on separator portion 311 utilizing the solution through coating, dipping, and/or spraying with (subsequent) removal of the solvent and non-solvent.

In one or more embodiments, a polymer material may represent about 5% to about 25% of the volume of a first layer of first insulator 316, and a stiffener material may represent about 75% to about 95% of the volume of the first layer of first insulator 316. The polymer material may include PVDF and/or PVDF-HFP. A first solution may be formed including the polymer material, the stiffener material, a solvent, and a non-solvent. Solid content may represent about 15% to about 45% of the first solution, and the solvent may represent about 85% to about 55% of the first solution. The first layer of first insulator 316 (and a first layer of second insulator 317) may be formed on separator portion 311 utilizing the first solution through coating, dipping, and/or spraying with (subsequent) removal of the solvent and non-solvent.

Subsequently, a second layer of first insulator 316 may be formed over the first layer of first insulator 317. A polymer material may represent about 60% to about 95% of the volume of the second layer of first insulator 316, and a stiffener material may represent about 5% to about 40% of the volume of the second layer of first insulator 316. The polymer material may include PVDF, PVDF-HFP, PEO, and/or PAN. A second solution may be formed including the polymer material, the stiffener material, a solvent, and a non-solvent. Solid content may represent about 15% to about 45% of the first solution, and the solvent may represent about 85% to about 55% of the second solution. The second layer of first insulator 316 (and a second layer of second insulator 317) may be formed on the first layer of first insulator 316 (and the first layer of second insulator 317) utilizing the second solution through coating, dipping, and/or spraying with (subsequent) removal of the solvent and non-solvent.

Electricity supply system 301 may also include a first conductor 321 electrically coupled with conversion unit 322 and configured to serve as an electrode of electricity supply system 301. First conductor 221 may be formed of material including one or more of copper, aluminum, nickel, tin, silver, gold, etc., and one or more of alloys thereof. First conductor 221 may be configured to transfer electrical charge between first conversation unit 222 and first packaging unit 234 and/or other conductive structures (e.g., conductive wires) for electrical coupling with an external circuitry for electricity supply or recharge. First conductor 221 may also be configured to prevent moisture intake and electrolyte leakage for electricity supply system 201.

Electricity supply system 301 may also include a first polymer unit 323 configured to cover first conductor 321, thereby protecting first conductor 321 and improving flexibility of first conductor 321. First polymer unit 323 may be formed of material including one or more of polyimide (PI), polyethylene terephthalate (PET), polyethylene naphthalate (PEN), Polystyrene (PS), polypropylene (PP), polyvinyl chloride (PVC), epoxy, acrylic acid reagent, etc.

First polymer unit 323 may be implemented on first conductor 321 through hot lamination with alignment. Alternatively or additionally, solder mask may be printed onto first conductor 321 through screen printing. Once the solder mask has cured or substantially cured, first polymer unit 323 may be attached onto first conductor 321.

First polymer unit 323 may include one or more via holes, such as via hole 393. The inside wall of via hole 393 may be coated or plated with a conductive material. Accordingly, a first electronic component 326 disposed on first polymer unit 323 may be electrically coupled with first conductor 321 through the conductive material in via hole 393 to receive electricity from electricity supply system 301.

In one or more embodiments, first polymer unit 323 may be formed of conductive polymer or polymer with conductive particles. Accordingly, there may be no need to implement via holes.

First electronic component 326 may include an antenna, a simple circuit and an RFIC, for example, in an active RFID application. Alternatively or additionally, electronic component 326 may include a flexible display, such as an OLED. Alternatively or additionally, First electronic component 326 may also represent a circuit layout layer configured to accommodate one or more electronic components.

First electronic component 326 may overlap with one or more of first conductor 321 and second conductor 331. With electrical conductivity provided by conductive via holes or conductive first polymer unit 323 in a substantial overlapped area, reliability of electrical coupling may he advantageously optimized. Further, packaging costs and foam factors of associated end products may be reduced.

Electricity supply system 301 may also include a second insulator 317, a second conductor 331, and a second polymer unit 331 having configurations and functions similar to those of corresponding counterparts, such as first insulator 316, first conductor 321, and first polymer unit 323. In one or more embodiments, first conductor 321 may represent a cathode of electricity supply system 301, and second conductor 331 may represent an anode of electricity supply system 301. An electronic component 327 also may be attached to second polymer unit 333 for receiving electricity from electricity supply system 301.

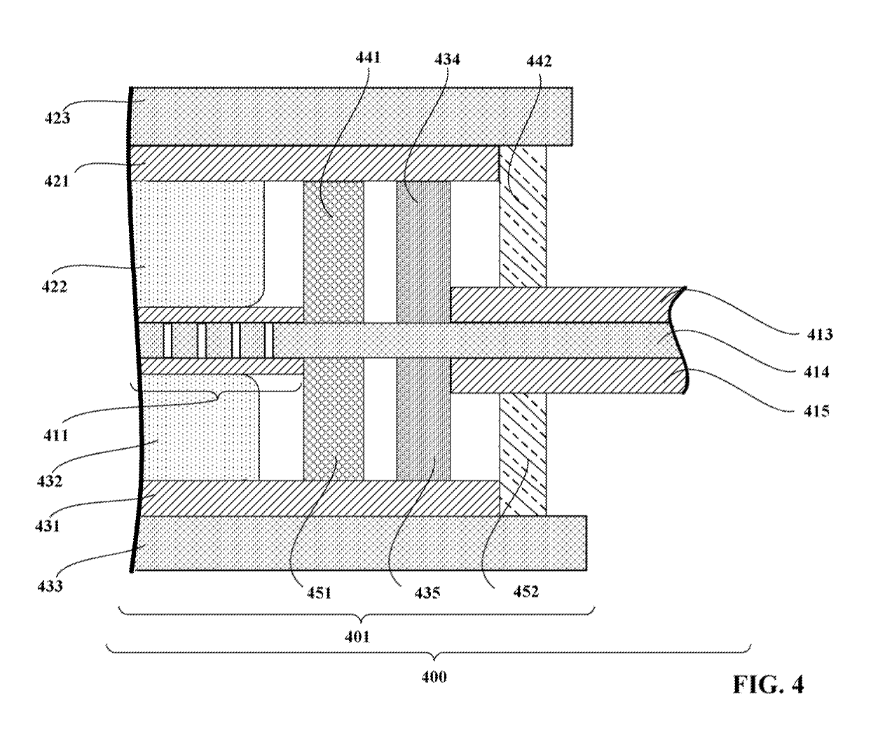

FIG. 4 illustrates a partial cross-sectional view of an electronic device 400 including an electricity supply system 401 in accordance with one or more embodiments of the present invention. Electricity supply system 401 may include conversion units 422 and 432, separator portion 411 of circuit substrate 414, conductors 421 and 431, and polymer units 423 and 433, which have configurations and functions similar to those of conversion units 322 and 332, separator portion 311, conductors 321 and 331, and polymer units 323 and 333, respectively, discussed in the example of FIG. 3.

Electricity supply system 401 may also include a first packaging unit 434 configured to enclose first conversion unit 422 to prevent electrolyte leakage and moisture intake. First packaging unit 434 may also be configured to conduct electricity between first conductor 421 and first conductive element 413 disposed on circuit substrate 414. Further, first packaging unit 434 may also be configured to structurally and mechanically coupled with first conductor 421 and circuit substrate 414 to promote distribution of stress, thereby enhancing structural robustness and flexibility of electricity supply system 401 and/or associated electronic device 400.

First packaging unit 434 may be formed of material including one or more of glue (e.g., with conductive particles), metal, fiberglass, etc. and one or more of combinations thereof. The glue may include one or more of PI, epoxy, acrylic acid reagent etc.

In one or more embodiments, first conductor 421, first packaging unit 434, first conductive element 413 may represent a manufactured pattern (for example, e.g., etched or micro/nano-machined pattern), of a single piece of a conductive material. Advantageously, reliability of electrical coupling may be ensured. Alternatively or additionally, Packaging unit 434 may be disposed between first conductor 421 and circuit substrate 414 through aligned adhesion and/or screen printing.

First packaging unit 434 may include a plurality of subunits. The subunits may have an offset arrangement or a stacking arrangement, for improving conductivity, adhesion, flexibility, and/or moisture-leakage resistance.

Electricity supply system 401 may also include a first support structure 442 disposed between first polymer unit 423 and first conductive element 413. First support structure 442 may be configured to maintain a space between first conductor 421 and at least one of second conductive element 415 and second conductor 431 to prevent a short circuit, for example, during manufacturing or use of electronic device 400, when the deformation of a portion of one or more of first conductor 421, second conductor 431 and second conductive element 415 may occur.

Electricity supply system 401 may also include first inert unit 441 disposed between first conversion unit 422 and packaging unit 434. First inert unit 441 may be chemically inert to both first conversion unit 422 and first packaging unit 434. Further, first inert unit 441 may be electrically non-conductive. First inert unit 341 may be formed of a material that includes one or more of glue, metal, electrical-chemical inert material, etc., or a combination thereof. If first inert unit 441 is formed of a metal material, the surface of first inert unit 441 may be inertized, such as oxidized and/or coated with polymer. First inert unit 441 may provide an additional layer (in addition to packaging unit 434) for preventing contamination and electrolyte leakage of first conversion unit 422. Advantageously, durability and performance of electricity supply system 401 may be ensured.

Electricity supply system 401 may also include a second packaging unit 435, a second support structure 452, and a second inert unit 451 having configurations and functions similar to those of corresponding counterparts, first packaging unit 434, first support structure 442, and first inert unit 441, respectively.

As can be appreciated from the foregoing, embodiments of the present invention may improve efficiency in manufacturing electronic devices. In general a circuit substrate can withstand high temperatures, such as a temperature higher than 300° C. Therefore, one or more mass production techniques, such as tin reflow, surface mount technology (SMT), etc, may be utilized to integrate electricity supply systems on circuit substrates (or circuit boards). For example, in one or more embodiments, electricity supply systems may represent SMT components that may be installed during the same SMT process for installing functional components. With the number of processes reduced, efficiency may be improved, and manufacturing costs of electronic devices may be reduced.

Further, with the integration of electricity supply systems and functional modules, manufacturing and material costs for providing packaging and electrical coupling may be reduced. Foam factors of electronic devices also may be reduced.

Since electricity supply components may be deployed on a circuit substrate with substantial maneuverability, embodiments of the invention may also provide more possibilities for electronic component layout. Accordingly, flexibility and variety of electronic device design may be provided.

Embodiments of the invention also provide improved structural/mechanical flexibility of electricity supply systems and/or electronic devices.

While this invention has been described in terms of several embodiments, there are alterations, permutations, and equivalents, which fail within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alternations, permutations, and equivalents as fall within the true spirit and scope of the present invention.

What is claimed is:

1. A system for supplying electricity to one or more electronic components, at least a first electronic component of the one or more electronic components being disposed on a circuit substrate, the system comprising:
a first conversion unit configured to perform a first chemical-electrical energy conversion;
a first conductor electrically coupled with the first conversion unit and representing a first electrode of the system;
a second conversion unit configured to perform a second chemical-electrical energy conversion;
a second conductor electrically coupled with the first conversion unit and representing a second electrode of the system; and
a separator disposed between the first conversion unit and the second conversion unit and configured to separate the first conversion unit from the second conversion unit,
wherein the separator is a portion of the circuit substrate, and the first electrode and the second electrode have different polarities.

2. The system of claim 1 wherein a second electronic component of the one or more electronic components overlaps at least one of the first conductor and the second conductor.

3. The system of claim 1 wherein the separator includes through holes with diameters greater than 10 microns.

4. The system of claim 1 further comprising a first insulator disposed between the first conversion unit and the separator, the first insulator including holes with diameters less than 10 microns.

5. The system of claim 4 further comprising a second insulator disposed between the second conversion unit and the separator, the second insulator including through holes with diameters less than 10 microns.

6. The system of claim 4 wherein the first insulator includes a plurality of layers with different composition recipes.

7. The system of claim 4 wherein the first insulator is formed of material including one or more of a polymer material and a ceramic material.

8. The system of claim 7 wherein the polymer material is configured to prevent particles of the ceramic material from concentrating at an interface between the first insulator and the first conversion unit.

9. The system of claim 7 wherein the polymer material includes one or more of PVDF, PFDF-HFP, and PI.

10. The system of claim 7 wherein the polymer material includes PVDF, PFDF-HFP, and PI.

11. The system of claim 1 further comprising a packaging unit configured to surround the first conversion unit the packaging unit electrically coupled with the first conductor and a conductive element disposed on the circuit substrate.

12. The system of claim 11 further comprising an inert unit disposed between the first conversion unit and the packaging unit, the inert unit being electrically non-conductive and inert to the first conversion unit.

13. The system of claim 12 wherein the inert unit includes at least one of an oxidized metal unit and a coated metal unit.

14. The system of claim 1 further comprising a supporting structure configured to maintain separation between the first conductor and at least one of the second conductor and a conductive element disposed on the circuit substrate, wherein the conductive element and the supporting structure are on different sides of the circuit substrate.

15. The system of claim 14 further comprising a polymer unit covering the first conductor and spanning beyond the supporting structure.

16. The system of claim 1 further comprising a polymer unit covering the first conductor.

17. The system of claim 16 wherein the polymer unit includes one or more via holes, and one or more inside walls of the one or more via holes are coated with conductive material.

18. The system of claim 1 wherein the separator is formed of material including at least one of PI, PET, PEN, glass fiber, and liquid crystal polymer.

19. The system of claim 1 wherein the circuit substrate is a flex circuit board.

20. An electronic device comprising:
a first conversion unit configured to perform a first chemical-electrical energy conversion;
a first conductor electrically coupled with the first conversion unit;
a second conversion unit configured to perform a second chemical-electrical energy con version;
a second conductor electrically coupled with the second conversion unit;
a circuit substrate including a separator portion, the separator portion disposed between the first conversion unit and the second conversion unit and configured to separate the first conversion unit from the second conversion unit; and
a first electronic component disposed on the circuit substrate and configured to consume electrical energy supplied by at least one of the first conversion unit and the second conversion unit,
wherein the first conductor and the second conductor have different polarities.

21. The electronic device of claim 20 wherein a second electronic component overlaps at least one of the first conductor and the second conductor, the second electronic component receiving electricity from the at least one of the first conductor and the second conductor.

22. The electronic device of claim 20 further comprising an insulator disposed between the first conversion unit and the separator portion, the first insulator including through holes with diameters less than 10 microns.

23. The electronic device of 20 further comprising a packaging unit configured to surround the first conversion unit, the packaging unit electrically coupled with the first conductor and a conductive element disposed on the circuit substrate.

24. The electronic device of 23 further comprising an inert unit disposed between the first conversion unit and the packaging unit, the inert unit being electrically non-conductive and inert to the first conversion unit.

25. The electronic device of 20 further comprising a polymer unit covering the first conductor, wherein the polymer unit includes one or more via holes, and one or more inside wails of the one or more via holes are coated with conductive material.

26. The electronic device of 20 wherein the separator portion is formed of material including at least one of PI, PET, PEN, glass fiber, and liquid crystal polymer.
